(19) United States
(12) Patent Application Publication
(10) Pub. No.: US 2003/0159108 A1
(43) Pub. Date: Aug. 21, 2003

(54) Method for automatically protecting data from being unintentionally overwritten in electronic forms

(76) Inventor: Gerhard Spitz, Munchen (DE)

Correspondence Address: MORRISON & FOERSTER LLP, 1650 TYSONS BOULEVARD, SUITE 300, MCLEAN, VA, 22102, US

(21) Appl. No.: 10/221,341

(22) PCT Filed: Aug. 29, 2001
(86) PCT No.: PCT/DE01/03327

(30) Foreign Application Priority Data
Sep. 7, 2000 (EP) 00119576.7

(51) Int. Cl. G06F 17/21

(52) U.S. Cl. 715/505

(57) ABSTRACT

The invention relates to a method that can be applied to data processing programs that allow the user to repeatedly change data (10), especially programs that process electronic forms such as spreadsheet routines. The invention provides a method with which an erroneous overwriting of initially correct data (10) can be avoided. To this end, the method allows an automatic selection of critical data (12), that is data that shall not be overwritten, from the quantity of data (10) to be processed. Said critical data (12) are automatically protected from being unintentionally overwritten.

The invention relates to a method for protecting data to be safeguarded in data-processing programs comprising accessible data and data to be protected.

In data-processing programs that employ electronically generated forms, such as table-calculation programs, the electronic forms are often used multiple times and by different users. The forms comprise data that can be modified, and critical data, that is, data that are only to be overwritten under specific circumstances, such as presentations and calculations in tables. After critical data have been entered once, they should not be able to be accidentally modified during later use of the program. Unfortunately, to this point there has been no means of automatically protecting critical data against unintentional access. The inadvertent, and therefore incorrect, modification of critical data can cause extensive sequence errors that skew the overall program result, without it being apparent which minor error was actually responsible.

The creators of programs that process critical data have not yet found a universal solution for this problem, because the selection of critical data from the total quantity of data to be processed is individual. In one case, the critical data comprise user-individual information about age, employee number, etc., while in another case a critical datum appears in the calculation of a certain cost point based on other data to be processed in the program.

As a result, the program creators have chosen to allow the respective user in individual cases to take responsibility for protecting against an undesired overwriting of critical data.

Until now, data protection has only been effected separately for each program application in individual cases. The program user has always had to perform an additional step and manually select the data that he considers to be critical from the quantity to be processed, in order to define a write protection for them. Of course, errors occur more frequently in this procedure, for example because certain data may be overlooked, then inadvertently overwritten later in a further application of the program using these data.

This problem exists for all programs that utilize an electronically generated data structure (e.g., forms) that may be modified in a later application of the program possibly by different users—such as document excerpts of Word presentations, table pages and cells in Excel, etc.

It is therefore the object of the present invention to make available a method that can be applied to different programs with different applications that process critical data, that is, data that are not be altered after they have been entered once, so the critical data are protected from an undesired access, particularly overwriting.

In accordance with the invention, this object is accomplished by the method mentioned at the outset, particularly a method for automatic protection of data, comprising the following steps:

a) the read-in of data;

b) the automatic identification of the data to be protected; and

c) the protection of the identified data and/or the data to be protected through a safeguarding against an unintentional access.

In a preferred embodiment of the invention, the method is designed for programs that process electronically generated forms, such as table-calculation programs.

In this instance, the program typically generates a form for an application, with data being entered into the form or read in from other programs. Other data are calculated on the basis of these data. If the application relates to cost calculation, for example, the value-added tax of an amount may be entered into a field, as a function of a value. The fundamental consideration of the solution in accordance with the invention is that the value should be accessible in later applications, but not the calculation—the base formula for the value-added tax, so to speak. This datum is therefore a critical datum, and should be protected from an undesired access, such as overwriting, by a user of the program. Other data are also critical, however. For example, in personnel management, it may be necessary to perform a calculation that incorporates employee numbers. These should also not be allowed to be overwritten provided that they have been entered correctly in the first place.

In accordance with the invention, these critical data are automatically detected and provided with protection. The user therefore need not manually identify the critical data in each application, then protect them specifically against modifications and/or reading access.

The method is basically conceptualized for automatically protecting data from an unintentional access that may occur in a write access and/or a read access.

The latter case is practical, for example, when certain formulas in a table-calculation form are not intended to be forwarded to clients, but the calculation—the result, so to speak—is to be made available. Then, the data fields based on a calculation are automatically selected in accordance with the invention, and automatically provided with read protection, so only the result of the calculation is visible.

In an advantageous, alternative embodiment of the invention, classes of users can be defined in this method. Different levels of protection can be established for these different users. Depending on the class association of the user, he has a quantity of critical data that may vary from class to class. In the above-described example of the electronic personnel management, it is advantageous to set up a user class of so-called “super users,” for example the managers of the personnel department, who are essentially authorized to modify any data. In addition to this class, a user class can be established for the individual employees. It is desirable for the respective employee to have access to (select) data that he is allowed to modify, such as information about projects with which he is involved, etc.

The method according to the invention can, of course, also be categorized in hierarchical fashion. If the employee wishes to add information to the same form, and the information is supposed to be entered, for example, in encoded form, the method of the invention can be employed such that the encoded entries can be modified by the employee or, optionally, arbitrary third parties, only with proper authorization, which prevents an undesired overwriting of these entries, and therefore errors.

A further, particularly preferred, embodiment of this method according to the invention encompasses a graphic surface, which appears when an identified critical datum is intended to be modified. The user is prompted to confirm that he in fact wishes to modify the critical datum, knowing that data may be lost. Once the user has confirmed this, and inputted his authorization for accessing this datum, he can overwrite the datum. This advantageously increases the security and reliability of the system.

An embodiment of the present invention that has proven advantageous in practice relates to the additional, optional manual identification of critical data. This is practical, for example, at those times when the user wishes to establish that a conventional set of data that has not automatically been identified is nevertheless not supposed to be overwritten. The user can make use of additional intervention options, and is not bound by the identification routines according to the invention.

In accordance with the invention, the user is also supported by the additional feature of being able to engage and disengage the automatic identification as desired. For example, if all of the previous entries in a form are to be reworked and updated, it is helpful if the confirmation for the desired overwrite does not have to be entered each time. According to the invention, the critical data are identified with a semantic and syntactic analysis of the individual data or data fields. If the data comprise a formula, a numeric value or a data set having a specific format, or a data set whose contents are, again, calculated from other values or are dependent on these values, they are identified as critical. This assessment is advantageously automated, so the user need not take any precautions in selecting the critical data from the total quantity of data.

Further advantages of the invention, and special embodiments and their features, are explained in the following, detailed description of the figures. Shown are in:

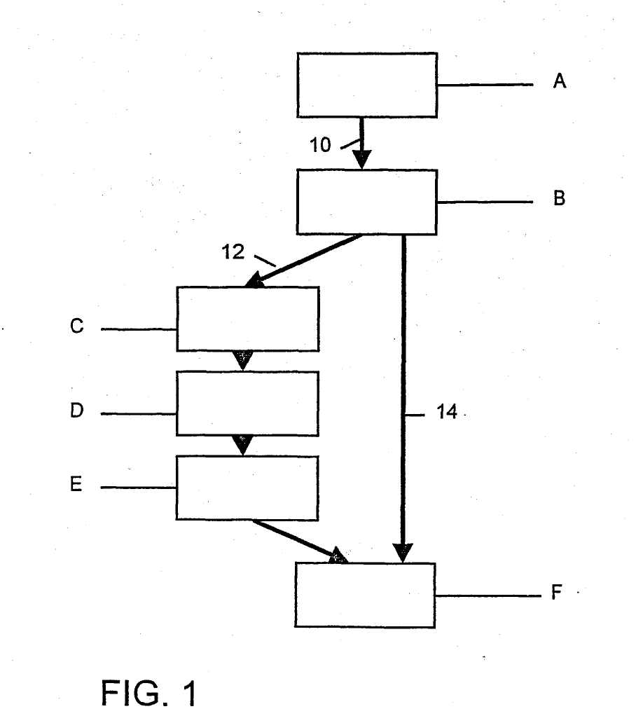

FIG. 1 a schematic representation of a process according to the invention; and

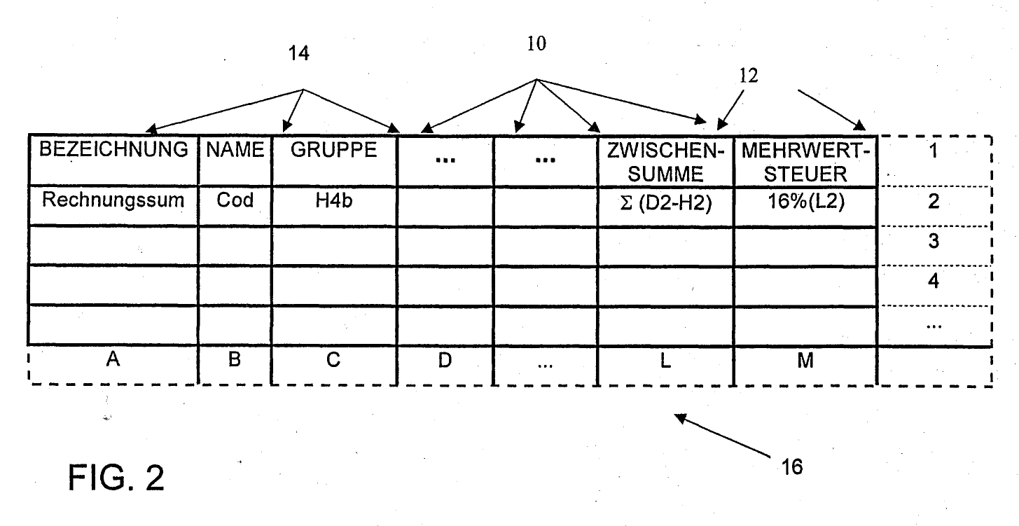

FIG. 2 a representation of a form with data that have been identified in accordance with the invention.

The general course of the method according to the invention is introduced below with reference to FIG. 1.

Many software solutions on the market generate and process electronic forms 16, which are to be further processed in later sessions by the same user or other users. The user manually enters data 10 or, alternatively, they are read in automatically via an interface of other programs (Step A). In the preferred embodiment of the invention, the method is applied to a table-calculation program. Here, the super user creates a form that contains formulas and calculations in addition to data 10. Depending on the application of the program, the crux of the work lies in the selection of the calculations—for example, the calculation of work hours, taking into account entries of breaks and fixed work periods, or financial calculations, taking into account entries of taxes, capital, etc. This form 16 is then “distributed” (electronically) to the user, who in turn enters data 10 into the form 16. If the user inadvertently enters data 10 into the form field containing a calculation, the calculation is nullified; subsequent calculations based on this value may be nullified as well. The automatic protection according to the method of the invention reliably prevents this error.

If the table-calculation program is used to draw up a cost sheet, for example, the data 10 are contained in entries for individual cost positions, which must be variably modified, and those that are calculated from these costs, such as value-added taxes, turnover taxes, subtotals and totals, etc. The individual cost positions are non-critical data 14, namely those that must be accessible for modification, and must be able to be overwritten. The other data are, however, to be classified as critical data 12, because they are calculated with a formula from other data 12. The VALUE-ADDED TAX data field is based on, for example, the following formula: “16%*‘Value of a SUBTOTAL data field.’” If the value of the SUBTOTAL data field is to be modified, the value of the VALUE-ADDED TAX data field should be modified, but not its calculation. Therefore, the VALUE-ADDED TAX data field counts as critical data 12.

In Step B, the method of the invention automatically recognizes the critical data 12 and selects them from the quantity of data 10.

Subsequently, in Step C, the critical data 12 are protected against an unintentional access, particularly overwriting.

The data identified as critical are advantageously made known to the user in Step D, for example through the use of color or shading.

If the user wishes to modify critical data 12, a surface 18 (not shown) appears in Step E, indicating to the user the critical quality of the datum and prompting him to confirm the modification of this datum.

In Step E, the method checks whether the user is authorized to modify the selected datum. If the access authorization is present, the program proceeds with the access, for example overwriting the datum. If no access authorization is present, the data remain unmodified, and/or the base calculation is not displayed.

The data 10 are then conventionally further processed in Step F. In Step F, the data 14 identified as non-critical in Step B are likewise processed.

It is also within the spirit of the invention to protect critical data 12 against an inadvertent read access. This is necessary, for example, when a form 16 that was electronically generated from a table-calculation program is to be forwarded (e.g., to clients), but the detailed calculations are not to be accessible and therefore should be protected from access (here: read access). Then, the client can only view the value of the respective data field, but not its base formula.

In practice, this results in the significant advantage that not only can a complete read protection be established for the entire form 16—as was previously the case—but a selective, partial read protection is also possible for select data groups.

The automatic identification of critical data 12 is effected with a set of rules. These rules are based on a semantic and syntactic analysis of the data 10 to be checked. Following are examples of possible rules:

‘Is a formula/calculation present?->The datum is a critical datum.’

‘Does the entry comprise mathematical operators?->The datum is a critical datum.’

‘Is the entry specifically formatted?->The datum is critical.’

‘Does the datum comprise numeric characters?->The datum is critical.’

‘Has the datum been created by a group of predetermined users?->The datum is critical.’

‘Is the datum at least part of a piece of information relating to a predetermined content (e.g., personnel information)?->the datum is critical,’ etc.

In a preferred embodiment of the invention, the method employs so-called rule classes that were used to identify the critical data 12 in Step B. A class of rules contains one or more variables whose value is determined based on the current application of the program. In the above exemplary list of rules, they would be the following:

‘Has the datum been created by a group of predetermined users?->The datum is critical.’

‘Is the datum at least part of a piece of information relating to a predetermined content (e.g., personnel information)?->The datum is critical.’ The variables here are “predetermined users” and “predetermined content.” Depending on the application, the user defines these variables using a protection parameter surface. Thus, it is possible to adapt the identification of the critical data 12 to the respective application.

FIG. 2 illustrates an example of an electronically generated form 16, in which the critical data 12 are protected against undesired overwriting or reading with the aid of the method of the invention.

The method of the invention is not only used for the example of table calculation, but also for all programs for processing data 10 based on data structures that can be modified by the user, and in which the problem exists of protecting a partial quantity of the data 10 against an undesired access, as in presentation documents in text processing, in organization programs, scheduling programs and the like.

In accordance with the invention, the method offers the option of choosing whether the identification in Step B should be performed once or multiple times for each program application. For example, in a table-calculation form 16, which calculates and administers costs, it can be determined that the automatic identification and automatic protection against overwriting is to be performed only once for each application and data entry. This measure is preferably implemented only in protecting against an undesired writing access. As an alternative, it can be defined that the method according to the invention should be executed for each intended modification (here: write access).

Until now, safeguarding critical data 12 or data for which only select program users are authorized to modify the data (e.g., the super user) has been effected manually, via macroprogramming, for example.

It was not possible to select critical data 12 and non-critical data 14 automatically. According to the invention, this selection is effected with a set of rules that can be expanded by the user for the special application of the program.

The method of the invention is advantageously implemented in all input forms for data detection. Here, the user must enter his personal data into the corresponding cells. The other cells, such as globally relevant data or data from other users, are not to be modified or read by this user.

The automatic identification is based on the set of rules. In this case, the rules encompass the detection of the authorization of the respective user to access the cell.

If no access authorization for the cell is present, the datum of the cell is identified as critical data.

In an alternative embodiment of the invention, the automatic identification based on the set of rules encompasses a weighting of the individual rules.

For example, it can be determined that, first and foremost, all numeric data that are found with mathematical operators in a cell, and all further rules for recognizing calculations, are automatically identified and provided with write protection. Then the rule for recognizing calculations and formulas takes the highest priority, and the other rules are given secondary priority. This procedure is particularly practical for table-calculation programs.

The method according to the invention advantageously provides the feature of purposefully activating and deactivating the automatic access protection. This is practical, for example, when a user—namely, the author of the form 16—is first creating the respective data sheet. Here, the write protection is advantageously deactivated, so he does not have to confirm that he actually intends to modify the value of a cell each time that he enters new information (and therefore makes a modification).

Additionally, or as an alternative, the method according to the invention can be implemented in an application of the program with one and the same data sheet for different users such that the write protection cannot be engaged and disengaged by the user, but the super user determines which user has which access authorization for the respective data, so the write protection is automatically activated if no authorization is present.

In the case of multi-user systems, such as Unix systems, an especially advantageous embodiment of the method according to the invention includes the functionality of automatically detecting the user's authorization and automatically activating the write protection when no overwrite authorization is present for this datum. In these systems, the downloading of the program from a certain computer can be traced to the user. From this connection, the system can derive his authorization and automatically permit access only to the data for which the respective user has authorization.

The primary application of the method according to the invention, however, is in the embodiment as an “add-on” to table-calculation programs on the market.

The method preferably encompasses the following procedure:

1. The super user creates a form 16 for the respective application.

2. The form 16 is distributed to the various users.

3. The super user modifies the form 16 by changing several calculations in the form of formulas.

4. The new form 16 (with the new formula) is automatically distributed to the users with write protection.

5. The users enter data 10 into the form 16.

The invention provides numerous embodiments for protecting the identified data 12 to be safeguarded against an undesired overwriting. One option is to monitor the confirmation of the user. Following confirmation, the identified, critical datum 12 can be modified. If there is no confirmation, the datum 12 remains unchanged.

Another option is to provide password protection. In this instance, the critical data 12 are automatically protected because they can only be modified after the respective user has entered a password. As an alternative, the user can advantageously activate or deactivate the automatic write protection for the entire data set to be processed, or for the entire form 16, or for only individual, select classes of data (e.g., a column or line in the form), or only for individual, special data.

The safeguarding against undesired access, particularly overwriting, is effected through the detection of the user's access authorization for the respective data cells.

The method is essentially applicable in all programs for processing data 10, the programs being specified for re-processing at least a portion of the read-in and/or processed data 10 in a later application, such as text presentations, tables and forms, and/or the method is applicable in those programs in which a plurality of users has access to a data sheet.

1. A method for protecting data (12) to be protected in programs for processing data (10), the programs comprising accessible data (14) and data (12) to be protected, the method comprising the following steps:
a) the read-in of data (10);
b) the automatic identification of the data to be protected (12); and
c) the protection of the identified data and/or the data (12) to be protected through a safeguarding against an unintentional access.

2. The method according to claim 1, characterized in that the method can arbitrarily be activated and deactivated within the program for individual classes of data (10).

3. The method according to at least one of the foregoing claims, characterized in that the identified data are automatically protected.

4. The method according to at least one of the foregoing claims, characterized in that a manual protection of the data (12) to be protected is effected arbitrarily and/or additionally.

5. The method according to at least one of the foregoing claims, characterized in that the unintentional access is a write access, and the method protects write-protected data (12).

6. The method according to claim 5, characterized in that the safeguarding against an unintentional access encompasses the following:
the calling up of a surface (18) that prompts a user to confirm the desire to modify the data (12) to be protected.

7. The method according to at least one of the foregoing claims, characterized in that the unintentional access is a reading of the data (12), and the method protects read-protected data (12).

8. The method according to at least one of the foregoing claims, characterized in that the data (12) to be protected are identified through a semantic and/or syntactic analysis of the data (10), especially through the recognition of formulas and numeric and/or specifically formatted data (10) and/or the detection of access authorization of the users.

9. The method according to at least one of the foregoing claims, characterized in that the data (10) are read in through a data input by a user.

10. The method according to at least one of the foregoing claims, characterized in that the data (10) are automatically read in via an interface to other programs.

11. The method according to at least one of the foregoing claims, characterized in that the method comprises a further step:
d) the display of the identified data.
